(19) United States
(12) Patent Application Publication
(10) Pub. No.: US 2010/0189903 A1
(43) Pub. Date: Jul. 29, 2010

(54) INK CONTAINING CARBON NANOTUBE, METHOD FOR APPLYING THE SAME AND METHOD FOR PRODUCING PLASMA DISPLAY PANEL

(75) Inventor: Toshiyuki AOYAMA, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/695,489

(22) Filed: Jan. 28, 2010

(30) Foreign Application Priority Data
Jan. 28, 2009 (JP) 2009-016177

(51) Int. Cl. C08K 3/04; B05D 5/00

(52) U.S. Cl. 427/256; 524/588; 524/495; 977/742

(57) ABSTRACT

The present invention provides an ink containing a carbon nanotube with low viscosity and high dispersibility of the carbon nanotube. The present invention provides an ink containing a carbon nanotube, an organic solvent, a binder, and a dispersant, wherein the dispersant is at least one dispersant selected from the group consisting of a polyalkylol amine salt dispersant, and a polyether-modified polyalkylsiloxane dispersant.

### BACKGROUND OF THE INVENTION

1. Field of the Invention

The present invention relates to an ink containing a carbon nanotube, particularly to an ink for ink-jet printing containing a carbon nanotube. The present invention also relates to a method for applying an ink. The present invention further relates to a method for producing a plasma display panel (PDP).

2. Description of Related Art

A carbon nanotube is a material that exhibits unprecedented excellent properties such as a high electric conductivity, electron emission properties, and high mechanical properties. Hence, many studies for practical use and application of the carbon nanotube in a wide variety of fields have been made.

The carbon nanotube is obtained generally as an aggregate. Therefore, disintegration of the aggregate to separate into dispersed primary particles is required for the practical use and application. However, as is known, dispersion of the carbon nanotube is generally difficult, and many efforts by various methods have been made so far for allowing the carbon nanotube to be dispersed so as to form an ink (e.g., see JP 2007-297255 A).

On the other hand, in the practical use and application of the carbon nanotube, there is an important problem in putting the carbon nanotube in a given position, that is to say, patterning the carbon nanotube. For the patterning of the carbon nanotube, generally printing techniques are employed, and a screen printing method, ink-jet method, and the like have been explored. Particularly, the ink-jet method is suitable for fine patterning, and many studies of the ink-jet method have been made so far.

For the ink-jet method, only an ink with low viscosity can be used generally because of the nature of the ink-jet method. Furthermore, high dispersibility of a carbon nanotube in an ink is required. When an ink with high viscosity is used, an ink-jet nozzle can not discharge the ink using a piezo element, and thereby patterning can not be achieved. Furthermore, when the dispersibility of the carbon nanotube is poor, clogging of the ink-jet nozzle occurs because the nozzle has a diameter of only several tens of μm.

Here, when an ink containing a carbon nanotube is patterned using an ink-jet method, the carbon nanotube has poor dispersibility, and therefore, it is very difficult to achieve both low viscosity and high dispersibility. Accordingly, no ink for ink-jet printing with both sufficient dispersibility of a carbon nanotube and low viscosity has been obtained yet. Consequently, fine patterning of a carbon nanotube using an ink containing a carbon nanotube by an ink-jet method can not be established stably.

On the other hand, the carbon nanotube can be used in a PDP as an electron emission material. It is studied to apply an ink containing a carbon nanotube to a panel or barrier ribs by an ink-jet method in a production process of a PDP (e.g., see JP 2006-216339 A). If the fine patterning of a carbon nanotube using an ink containing a carbon nanotube by an ink-jet method can be established stably, it is possible to reduce the driving power of a PDP.

### SUMMARY OF THE INVENTION

It is an object of the present invention to provide an ink containing a carbon nanotube with low viscosity and high dispersibility of the carbon nanotube. It is another object of the present invention to provide a method for applying an ink that makes it possible to establish fine patterning of a carbon nanotube stably. It is yet another object of the present invention to provide a production method whereby a PDP with low driving power can be produced.

To achieve the objects of the present invention, the present invention provides an ink containing a carbon nanotube, an organic solvent, a binder, and a dispersant,

wherein the dispersant is at least one dispersant selected from the group consisting of a polyalkylol amine salt dispersant, and a polyether-modified polyalkylsiloxane dispersant.

Further, the present invention provides a method for applying an ink, including a step of applying the above ink by an ink-jet method.

Furthermore, the present invention provides a method for producing a plasma display panel including a discharge space formed by a first panel, a second panel, and barrier ribs, wherein a carbon nanotube is placed facing the discharge space,

the method including a step of discharging the above ink containing a carbon nanotube to the first panel, the second panel, or the barrier rib using an ink-jet apparatus.

According to the present invention, an ink containing a carbon nanotube with low viscosity and good dispersibility of the carbon nanotube is provided. Furthermore, the ink has an excellent heat resistance. When the ink is used for application by an ink-jet method, fine patterning having a heat resistance of a carbon nanotube can be established stably. According to the production method of a PDP of the present invention, a PDP with low driving power can be obtained.

### BRIEF DESCRIPTION OF THE DRAWINGS

FIG. 1 is a graph of the particle size distributions of inks 1 and 2 of Examples and inks 3 and 4 of Comparative Examples.

FIG. 2 shows electron microphotographs of the particles onto which ink 1 of Example was applied, before and after firing.

FIG. 3 shows electron microphotographs of the particles onto which ink 2 of

Example was applied, before and after firing.

FIG. 4 shows electron microphotographs of the particles onto which ink 3 of Comparative Example was applied, before and after firing.

FIG. 5 shows electron microphotographs of the particles onto which ink 4 of Comparative Example was applied, before and after firing.

FIG. 6 shows an example of the PDP produced by the production method of the present invention.

### DETAILED DESCRIPTION OF THE INVENTION

First, the ink of the present invention will be described. The ink of the present invention contains a carbon nanotube, an organic solvent, a binder, and a dispersant, as essential components. These essential components will be described in detail below.

### (Carbon Nanotube)

The kind of the carbon nanotube to be used in the present invention is not particularly limited, and any of a single-walled carbon nanotube, double-walled carbon nanotube, and multi-walled carbon nanotube may be used depending on its application. From the view point of ease of dispersion, the double-walled carbon nanotube or multi-walled carbon nanotube is preferable. The diameter of the carbon nanotube is not particularly limited either, but is preferably 0.5 nm to 200 nm. The maximum length of the carbon nanotube needs to be shorter than a diameter of an opening of a nozzle used for ink-jet printing, and is preferably 10 μm or less, more preferably 5 μm or less, further more preferably 0.1 μm to 2.5 μm. The carbon nanotube with a short maximum length is advantageous also from the view point of dispersibility. A method for producing the carbon nanotube is not particularly limited, but with respect to a carbon nanotube produced using a catalyst, it is preferable that the catalyst be removed in the production method.

### (Organic Solvent)

As the organic solvent to be used in the present invention, common organic solvents may be used, but a solvent with high solubility of the after-described binder and dispersant preferably is used. The surface tension of the organic solvent is not particularly limited, but is preferably 20 dyn/cm or more for an ink-jet method. Specifically, preferable examples of the organic solvent include alkylene glycols such as ethylene glycol, and propylene glycol; alkylene glycol alkyl ethers such as propylene glycol monomethyl ether, and dipropylene glycol monoethyl ether; alkylene glycol alkyl ether acetates such as propylene glycol monoethyl ether acetate, dipropylene glycol monoethyl ether acetate, and diethylene glycol monobutyl ether acetate; and terpenes such as terpineol. These may be used alone and two or more kinds of them may be used in combination. It is preferable that the organic solvent contain at least one solvent selected from the group consisting of alkylene glycols, alkylene glycol alkyl ether acetates, and terpenes, because these have suitable surface tension and viscosity as well as high solubility of the dispersant and binder.

### (Binder)

As the binder to be used in the present invention is not particularly limited, and binders including various resins may be used. Specifically, the binder includes preferably an acrylic resin or a cellulose resin, particularly preferably ethyl cellulose.

### (Dispersant)

The dispersant to be used in the present invention is at least one dispersant selected from the group consisting of a polyalkylol amine salt dispersant, and a polyether-modified polyalkylsiloxane dispersant. Examples of the polyalkylol amine salt dispersant include DISPERBYK-180, DISPERBYK-182, and DISPERBYK-184, manufactured by BYK-chemie GmbH. Examples of the polyether-modified polyalkylsiloxane dispersant include polyether-modified polydimethylsiloxane (e.g., BYK-300, BYK-301, BYK-302, BYK-306, BYK-307, BYK-310, BYK-330, BYK-331, BYK-333, BYK-337, BYK-341, BYK-344, BYK-345, BYK-348, and BYK-378, manufactured by BYK-chemie GmbH, etc.), polyether-modified polymethylalkylsiloxane (e.g., BYK-320, and BYK-325, manufactured by BYK-chemie GmbH, etc.), polyether-modified hydroxyl group-containing polydimethylsiloxane (e.g., BYK-377 manufactured by BYK-chemie GmbH, etc.), and polyetherester-modified hydroxyl group-containing polydimethylsiloxane (e.g., BYK-375 manufactured by BYK-chemie GmbH, etc.). Particularly, polyetherester-modified hydroxyl group-containing polydimethylsiloxane is preferable.

### (Ink Composition)

The composition of the ink of the present invention is not particularly limited as long as the ink contains the above essential components and can function as an ink. In this regard, when the content of the carbon nanotube is excessively high, its dispersibility may be deteriorated. On the other hand, when the content of the carbon nanotube is excessively low, its dispersibility is good but a utility value of the ink may be lowered. When the content of the binder is excessively high, the viscosity of the ink increases and there may be some cases where the application of the ink by an ink-jet method is difficult. The content of the dispersant has the same tendency. Hence, a preferable composition range is as follows. It should be noted that “%” denotes “% by mass” in the total mass of the ink.
Carbon nanotube: 0.01% to 5%
Organic solvent: 80% to 99%
Binder: 0.1% to 10%
Dispersant: 0.1% to 5%

A more preferable composition range is as follows.
Carbon nanotube: 0.01% to 1%
Organic solvent: 90% to 99%
Binder: 0.1% to 5%
Dispersant: 0.1% to 5%

In order to use the ink of the present invention suitably for ink-jet printing, it is preferable that the ink composition be adjusted so that the viscosity of the ink is 15 cP or less and the surface tension of the ink is 25 dyn/cm to 40 dyn/cm. It should be noted that the viscosity of the ink can be measured using, for example, a sine-wave vibro viscometer and that the surface tension of the ink can be measured by, for example, a pendant drop method.

It should be noted that the ink of the present invention further may include an antioxidant, a flame retardant, a filler, and the like. In this case also, it is preferable that the viscosity and the surface tension be adjusted in the above range.

### (Dispersion Method)

The dispersion method of the ink is not particularly limited, and known methods can be employed. Specifically, a bead mill dispersion method, an ultrasonic dispersion method, a roll mill dispersion method, and the like are preferably used, and among them, the ultrasonic dispersion method is particularly preferable from the view point of dispersion stability and shape stability of a carbon nanotube.

The ink of the present invention constitutes an ink containing a carbon nanotube with low viscosity and good dispersibility of the carbon nanotube. The ink of the present invention further has an excellent heat resistance. When the ink is used for application by an ink-jet method, fine patterning having a heat resistance of a carbon nanotube can be established stably.

Hence, in another aspect, the present invention is a method for applying an ink, including a step of applying the above-described ink by an inkjet method.

The method can be performed by discharging the above-described ink to an object by a known ink-jet printing apparatus.

Examples of the object to which the ink is applied include a panel or barrier rib of a PDP, and an electron emission portion of a field emission display (FED).

In a PDP, the carbon nanotube serves as an electron emission material. When the above-described ink is applied to a panel or barrier rib of the PDP, the driving power of the PDP becomes low and the electric power of the PDP can be saved.

Hence, in yet another aspect, the present invention is a method for producing a plasma display panel including a discharge space formed by a first panel, a second panel, and barrier ribs, wherein a carbon nanotube is placed facing the discharge space,

the method including a step of discharging the above-described ink containing a carbon nanotube to the first panel, the second panel, or the barrier rib using an ink-jet apparatus.

The production method of the present invention can be performed by carrying out ink-jet printing using the above-described ink of the present invention instead of a known ink containing a carbon nanotube in a known method for producing a PDP in which a carbon nanotube is placed facing a discharge space.

If the ink is applied onto the first panel or the second panel, the ink may be applied to a dielectric layer, a protective layer, or a phosphor layer.

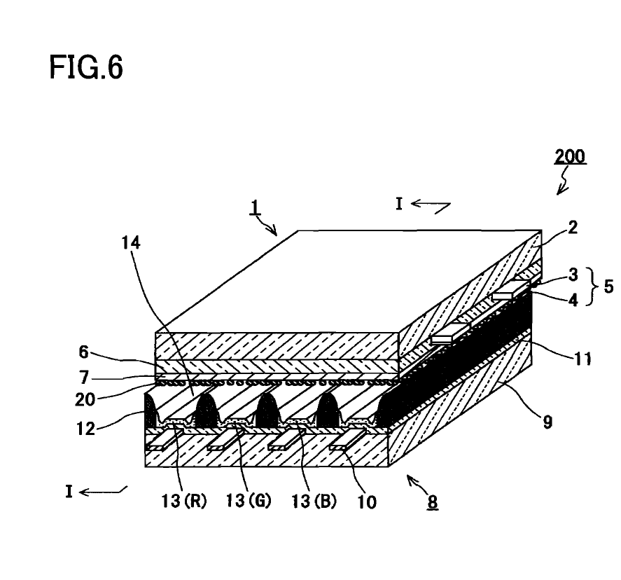

One example of manufacturing a PDP according to the production method of the present invention will be described with reference to FIG. 6. First, a first panel (front panel) 1 is produced. A plurality of linear transparent electrodes 3 are formed on one main surface of a flat front glass substrate 2. Subsequently, a silver paste is coated on the transparent electrodes 3, and then a silver paste is fired by heating the entire front glass substrate 2 to form bus electrodes 4. Thus, display electrodes 5 are formed.

A glass paste containing glass for a dielectric layer 6 of a PDP 200 is applied to the main surface of the front glass substrate 2 by a blade coating method so as to cover the display electrodes 5. Thereafter, the glass paste is dried by maintaining the entire front glass substrate 2 at 90° C. for 30 min, and then fired at around 580° C. for 10 min.

A film is formed on the dielectric layer 6 by electron beam evaporation of magnesium oxide (MgO), and fired to form a protective layer 7. The firing temperature is at around 500° C.

The ink of the present invention is applied onto the protective layer 7 by an ink-jet method, dried and then fired at around 500° C. to form a layer on which carbon nanotubes 20 are dispersed (in the figure, the carbon nanotubes are shown as circles for convenience' sake).

Next, a second panel (back panel) 8 is produced. A silver paste is applied onto one main surface of a flat back glass substrate 9 in the form of several lines, and then fired by heating the entire back glass substrate 9 to form address electrodes 10. Subsequently, a dielectric layer 11 is formed in the same manner as the front panel.

A glass paste is applied between the adjacent address electrodes 10, and fired by heating the entire back glass substrate 9 to form barrier ribs 12.

Phosphor inks of each color of red (R), green (G), and blue (B) are applied between the adjacent barrier ribs 12, and fired by heating the back glass substrate 9 to about 500° C. to remove a resin component (binder) and the like in the phosphor inks. Thus, phosphor layers 13 are formed.

The front panel 1 and back panel 8 thus obtained are bonded together using sealing glass. The temperature for this process is around 500° C. Thereafter, a sealed inside space is evacuated to high vacuum, and then filled with a rare gas.

The PDP 200 in which the carbon nanotubes 20 are placed facing a discharge space 14 thus is obtained.

### Examples

Hereinafter, an embodiment of the present invention will be described in more detail with reference to Examples and Comparative Examples. The present invention is not limited by these Examples.

### Example 1

Ink 1 was prepared as follows. 18 g of diethylene glycol monobutyl ether acetate and 12 g of alpha-terpineol as organic solvents were mixed and stirred thoroughly. Thereafter, 300 mg of ethyl cellulose as a binder was added thereto and dissolved therein. After ethyl cellulose was dissolved completely, 1 ml of a polyalkylol amine salt (DISPERBYK-180 manufactured by BYK-chemie GmbH) as a dispersant was added thereto, and the mixture was stirred thoroughly. Then, 75 mg of a carbon nanotube was added thereto and dispersed using an ultrasonic dispersion apparatus. The carbon nanotube used here is a multi-walled carbon nanotube having a diameter of 10 nm to 30 nm and length of 1 μm to 2 μm.

### Example 2

Ink 2 was obtained in the same manner as the ink 1 except that a dispersant indicated in Table 1 was used instead.

### Comparative Example 1

Ink 3 was obtained in the same manner as the ink 1 except that no dispersant was added.

### Comparative Example 2

Ink 4 was obtained in the same manner as the ink 1 except that a dispersant indicated in Table 1 was used instead.

TABLE 1

| | | Organic solvent 1 | | Organic solvent 2 | | Binder | | Dispersant | |
|---|---|---|---|---|---|---|---|---|---|
| Example 1 | Ink 1 | Diethylene glycol | 18 g | Alpha- | 12 g | Ethyl cellulose | 300 mg | Polyalkylol amine salt | 1 ml |
| | | monobutyl ether acetate | | terpineol | | | | (DISPERBYK-180) | |
| Example 2 | Ink 2 | Diethylene glycol | 18 g | Alpha- | 12 g | Ethyl cellulose | 300 mg | Polyetherester-modified | 1 ml |
| | | monobutyl ether acetate | | terpineol | | | | hydroxyl group-containing | |
| | | | | | | | | polydimethylsiloxane | |
| | | | | | | | | (BYK-375) | |
| Comparative | Ink 3 | Diethylene glycol | 18 g | Alpha- | 12 g | Ethyl cellulose | 300 mg | None | |
| example 1 | | monobutyl ether acetate | | terpineol | | | | | |
| Comparative | Ink 4 | Diethylene glycol | 18 g | Alpha- | 12 g | Ethyl cellulose | 300 mg | Polyoxyethylene octylphenyl | 1.5 ml |
| example 2 | | monobutyl ether acetate | | terpineol | | | | ether (Triton(R) X-100) | |

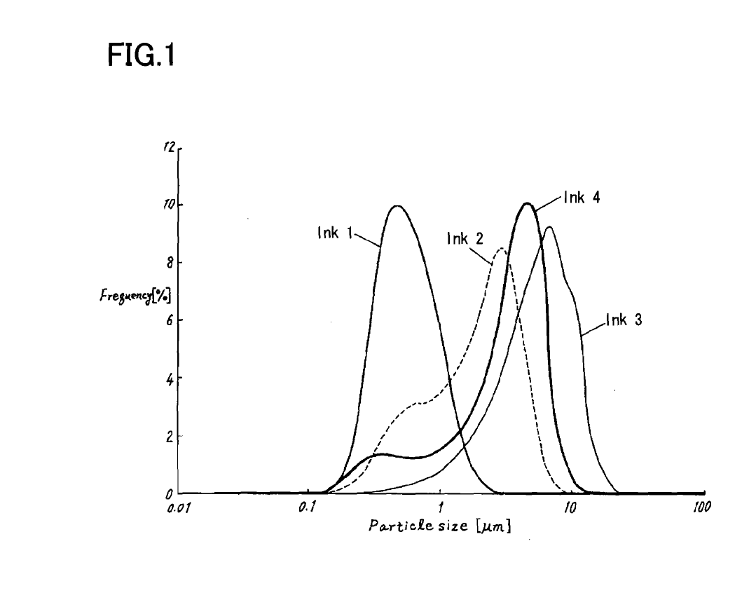

Using the inks 1 to 4 thus prepared, the following evaluations were conducted. After the components of the ink were dispersed, the ink stood overnight. An upper portion of the ink was taken out by decantation. The upper portion was subjected to a particle size distribution measurement with a laser diffraction/scattering particle size distribution analyzer (LA-910 manufactured by HORIBA) to evaluate the dispersibility of the carbon nanotube. In addition, a nozzle clogging was evaluated using an ink-jet apparatus by discharging each of the inks from a nozzle for one hour continuously. Further, the viscosity of each ink was measured using a sine-wave vibro viscometer SV-10 manufactured by A&D Company, Ltd. The surface tension of each ink was measured by a pendant drop method using a contact angle meter CA-V with FAMAS software manufactured by Kyowa Interface Science Co., Ltd. The results are shown in Table 2 and FIG. 1.

TABLE 2

| | | 50% | 80% | | Viscosity at | Surface |
|---|---|---|---|---|---|---|
| | | particle | particle | Discharge | room | tension |
| | | size (μm) | size (μm) | test | temperature (cP) | (dyn/cm) |
| Example 1 | Ink 1 | 0.44 | 0.71 | No | 8.8 | 29.5 |
| | | | | clogging | | |
| Example 2 | Ink 2 | 1.65 | 2.79 | No | 7.9 | 25.1 |
| | | | | clogging | | |
| Comparative | Ink 3 | 4.56 | 7.32 | Completely | 7.9 | 29.5 |
| example 1 | | | | clogged | | |
| Comparative | Ink 4 | 3.20 | 4.89 | Partially | 9.9 | 30.1 |
| example 2 | | | | clogged | | |

From the results shown in Table 2 and FIG. 1, it is clear that the inks 1 and 2 of Examples using at least one dispersant selected from the group consisting of a polyalkylol amine salt dispersant, and a polyether-modified polyalkylsiloxane dispersant have higher dispersibility of the carbon nanotube than that of the ink 3 using no dispersant and that of the ink 4 using another dispersant, and the inks 1 and 2 can be used satisfactorily for ink-jet printing.

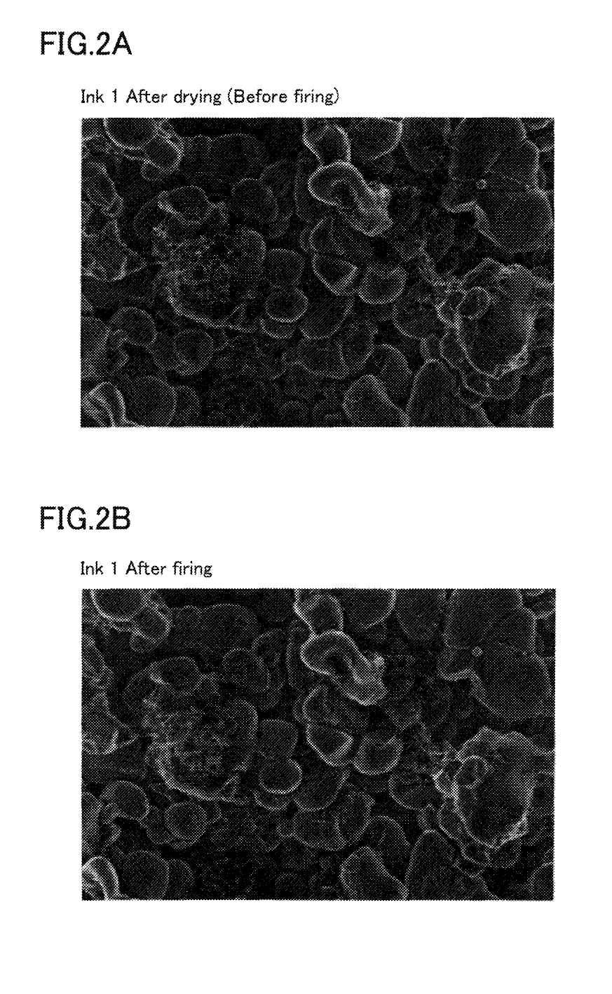

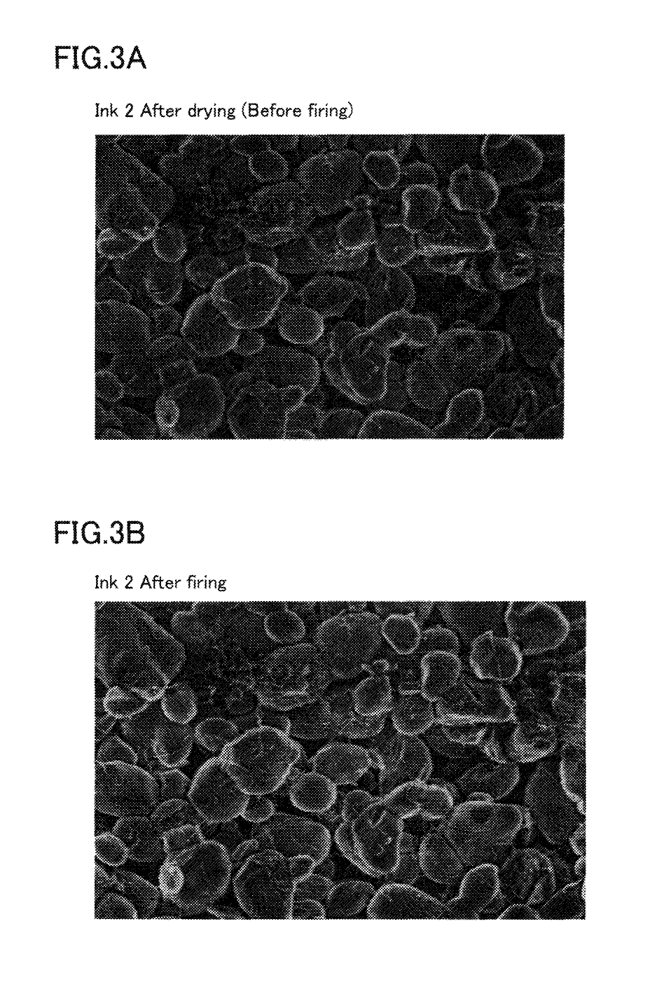

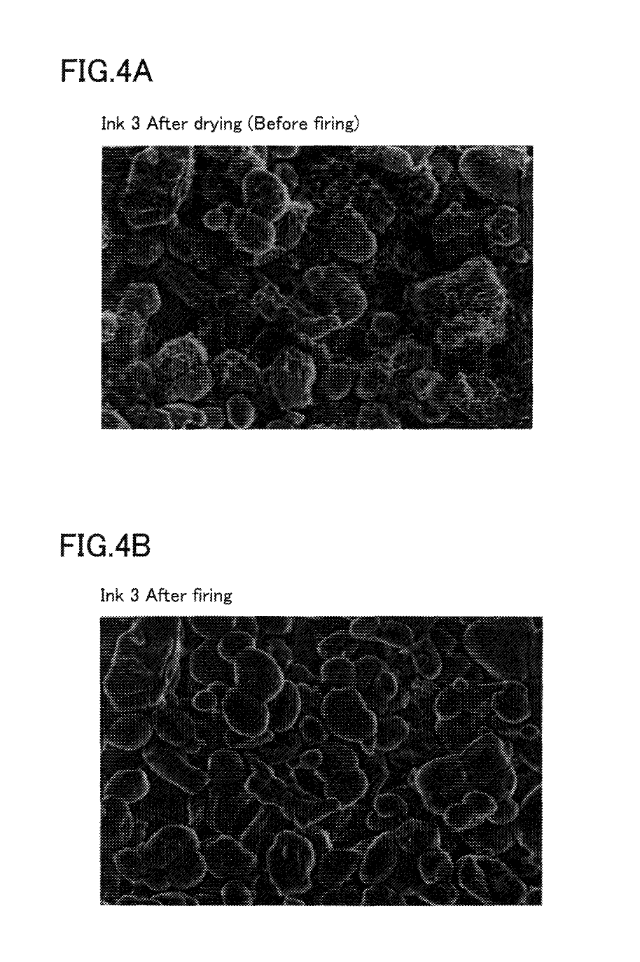

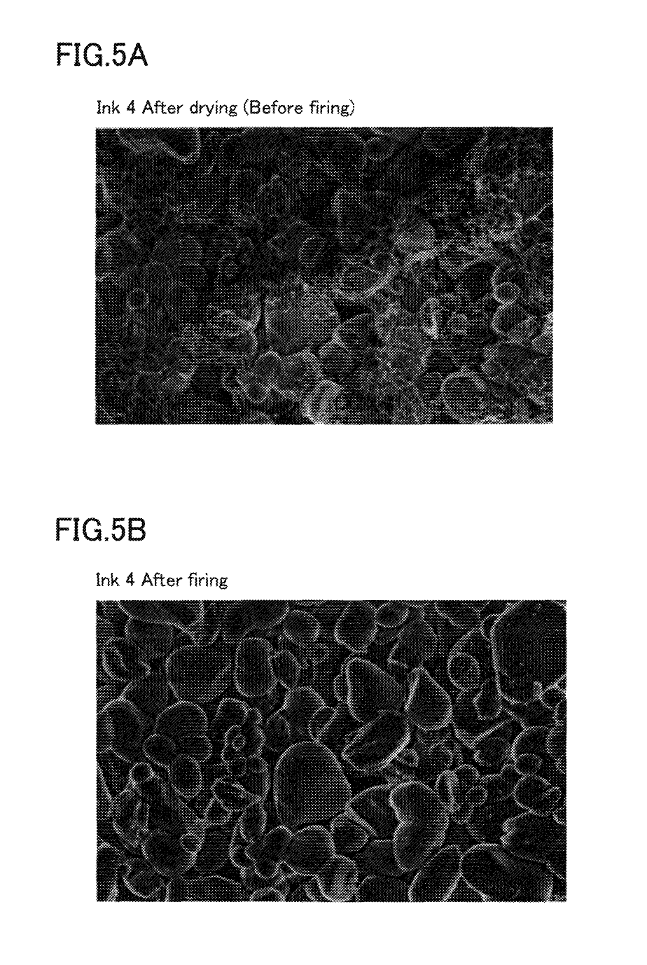

Next, an evaluation of a heat resistance was conducted. Each of the inks was applied onto particles, dried at 250° C. and then fired in the air at 500° C. for 30 min. The particles before and after firing were observed with a scanning electron microscope (SEM). The SEM photographs are shown in FIGS. 2 to 5. As can be seen in FIGS. 2 and 3, with respect to the inks 1 and 2 of Examples, the carbon nanotubes observed on the surfaces of the particles were little burnt out after firing. On the other hand, as shown FIGS. 4 and 5, with respect to the inks 3 and 4 of Comparative Examples, it is observed that the carbon nanotubes on the surfaces of the particles were burnt out. From this result, it is confirmed that the ink of the present invention has a high heat resistance.

In other words, when an ink is fired at a high temperature of 300° C. or more, such as 400° C. or 500° C., in a firing process for removing a binder, in the case of a conventional ink, a carbon nanotube can be burnt out together with the binder. However, according to the present invention, an ink containing a carbon nanotube with a sufficiently high heat resistance for firing at a high temperature can be provided.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

According to the present invention, an ink containing a carbon nanotube with viscosity and surface tension suitable for an ink-jet method can be provided. Using this ink, the carbon nanotube can be printed in a given pattern. In addition, since the ink has a high heat resistance, the ink can be used even in high temperature processes. Hence, the ink can be used widely in electronics applications for a conductive pattern, an electron emission source and the like.

What is claimed is:

1. An ink comprising a carbon nanotube, an organic solvent, a binder, and a dispersant,
wherein the dispersant is at least one dispersant selected from the group consisting of a polyalkylol amine salt dispersant, and a polyether-modified polyalkylsiloxane dispersant.

2. The ink according to claim 1, wherein the maximum length of the carbon nanotube is 5 μm or less.

3. The ink according to claim 1, wherein the viscosity of the ink is 15 cP or less and the surface tension of the ink is 25 dyn/cm to 40 dyn/cm.

4. The ink according to claim 1, wherein the organic solvent is at least one solvent selected from the group consisting of alkylene glycols, alkylene glycol alkyl ether acetates, and terpenes.

5. A method for applying an ink, comprising a step of applying the ink according to claim 1 by an ink-jet method.

6. A method for producing a plasma display panel including a discharge space formed by a first panel, a second panel, and barrier ribs, wherein a carbon nanotube is placed facing the discharge space,
the method comprising a step of discharging the ink containing a carbon nanotube according to claim 1 to the first panel, the second panel, or the barrier rib using an ink-jet apparatus.
